(19) United States
(12) Patent Application Publication
(10) Pub. No.: US 2011/0311177 A1
(43) Pub. Date: Dec. 22, 2011

(54) Suspension Thrust Bearing Device

(75) Inventors: Samuel Viault, Saint-Antoine-Du Rocher (FR); Richard Corbett, Fondettes (FR); Christophe Houdayer, Semblancay (FR); Desire Vidot, Joue-Les-Tours (FR); Bruno Montboeuf, Cerelles (FR)

(73) Assignee: AKTIEBOLAGET SKF, Goteborg (SE)

(21) Appl. No.: 13/161,676

(22) Filed: Jun. 16, 2011

(30) Foreign Application Priority Data
Jun. 16, 2010 (FR) 1054764

(51) Int. Cl. F16C 33/76

(52) U.S. Cl. 384/607

(57) ABSTRACT

A suspension thrust bearing device includes a lower cap, an upper cap having a surface portion, and a bearing disposed between the two caps. The bearing includes a lower race mounted on the lower cap, an upper race mounted on the upper cap, a plurality of rolling elements disposed between the two races, and a cage for retaining the rolling elements. The cage has a holding part for the rolling elements and a sealing lip extending from the holding part towards a periphery of the bearing, the lip including first and second integral legs extending in opposing directions. In certain embodiments, the first leg cooperates with the upper cap surface portion and the second leg cooperates with the lower race to form a seal. In other embodiments, the first leg cooperates with the lower race and the second leg cooperates with the upper cap surface portion to form a seal.

### CROSS-REFERENCE TO RELATED APPLICATIONS

This application claims priority to French patent application no. FR 1054764, filed on Jun. 16, 2010, which is incorporated fully herein by reference.

### BACKGROUND OF THE INVENTION

The present invention concerns the area of suspension thrust bearing devices used, in particular, on motor vehicles in the steered wheel suspension struts of motor vehicles.

Customarily, a suspension thrust bearing includes a roller bearing which forms an axial thrust bearing and includes a lower race and an upper race between which is arranged a row of rolling elements, for example balls or rollers. An angular contact ball bearing is preferably used allowing both radial loads and axial loads exerted on the suspension thrust bearing device to be picked up. The lower and upper races are generally mounted in contact with lower or upper bearing or supporting parts, such as cups or caps. The upper and lower caps form a housing for the bearing races and allow the interface between the races and the adjoining elements to be provided.

Such a suspension thrust bearing device is arranged in the upper part of the suspension strut between a suspension spring and an upper element that is integral with the vehicle body. The suspension spring is arranged around a rod of a damper piston, the end of which can be locked to the vehicle body by means of an elastic block that filters the vibrations. The suspension spring bears axially, directly or indirectly, on the lower support cap of the suspension thrust bearing device. The upper support cap, in its turn, is fixed in relation to the vehicle body.

The suspension thrust bearing thus allows axial loads to be transmitted between the suspension spring and the vehicle body whilst permitting a relative angular movement between the lower cap, which is movable in a rotational manner, and the upper cap. The relative angular movement can be the result of a steered wheel lock and/or from compression of the suspension spring.

The interior of the roller bearing, that is to say the space between the two races, contains a lubricant. To keep the roller bearing in good working order, it is advisable to keep the lubricant in the interior of the roller bearing, and at the same time prevent solid or liquid pollutants penetrating into the interior of the roller bearing. To this end, gaskets can be arranged at the junction between the two races. The gaskets can be fixed either to one of the races or to the holding cage of the rolling elements. In this latter case, a saving is made on cumbersome and sometimes costly slide systems when they have to be machined in one or other of the races. The speed of wear of a gasket that is integral with the cage, and rubs on the one or the other race, is less than that of a gasket that is fixed on one of the races and rubs on the other race.

Japanese patent application JP 2006 322556 describes such a bearing in the form of an axial thrust bearing with a metallic cage, on which are assembled double radial lips which comprise two superposed half lips, the axial section of which is a “V”, the point of which is attached to the cage. The end of each half lip comes into frictional peripheral contact with an edge of one of the races, the support between the half lip and the race being approximately radial.

This solution is difficult to implement, as if the lower cap is misaligned in a radial manner in relation to the upper cap, on account of, for example, manufacturing tolerances, the bearing has a frictional torque which is different to that anticipated in the non-mounted state of the bearing. This parasitic friction, not uniform over the periphery of the roller bearing, can cause unwanted noise generation and premature wear on the lips through rubbing. Moreover, significant peripheral loads between the lips and the metallic cage can separate the lips from the cage.

French patent application FR 2 779 096 (SKF) describes a suspension thrust bearing provided with a holding cage which is produced from synthetic material and is extended on one side or on both sides by one or several sealing lips which rub on the lower race, on the upper race, or on the upper cap. The sealing contacts of the lips are made, at least in part, with the left-hand surfaces, that is to say at the level of the sectionally varied fillets of the part contacted. This solution is not fully satisfactory either, as in the event of radial displacement of the upper part of the bearing in relation to the lower part of the roller bearing, the sealing lip, relatively rigid as realized in the same material as the central part of the holding cage, no longer provides the desired seal on one side of the bearing, and, on the other side of the bearing, is subjected to frictional loads that are markedly more significant than expected. This non-symmetrical friction will cause radial vibrations in the bearing.

Also known is international patent application WO 2008/081122, which describes a suspension thrust bearing comprising a sealing lip with two legs, respectively bearing radially on the upper cap and bearing axially on the lower cap. Although such a thrust bearing allows the sealing problem to be resolved, it does not allow the space taken up by the bearing to be reduced.

### SUMMARY OF THE INVENTION

The aim of the invention is to provide a suspension thrust bearing for which the frictional torque of the lips is approximately the same whatever the relative radial positioning of the lower and upper caps, at an attractive manufacturing price, with optimum sealing performance, while reducing the space taken up by the bearing.

In one aspect, the present invention is a suspension thrust bearing device comprising a lower cap, an upper cap and a bearing arranged between the lower cap and the upper cap, the bearing including a lower race mounted on the lower cap and an upper race mounted on the upper cap, a plurality of rolling elements disposed between the two races, and a holding cage for the rolling elements. The cage includes a holding part for holding the rolling elements and at least one sealing lip extending from the holding part toward an outer periphery of the bearing.

The sealing lip includes first and second integral legs (i.e., integrally formed or connected) extending in generally opposing directions so as to generally form a “broken line” shape, such as a “V”. In certain embodiments or constructions, the first leg cooperates with a surface portion of the upper cap and the second leg cooperates with the lower race so as to form a seal. In other embodiments/constructions, the first leg cooperates with the lower race and the second leg cooperates with the upper cap so as to form a seal.

The sealing lip comprising two legs, continuing on the one from the other following two distinct directions, provides a broken line and allows excellent sealing of the bearing to be obtained.

According to one embodiment, the first leg is in contact with a surface portion of the lower race and the second leg cooperates with a surface portion of the upper cap.

Thus, the first leg is in point contact with a surface portion of the lower race, allowing the sealing of the bearing to be increased.

The second leg can be in axial, radial or oblique contact with a surface portion of the upper cap or can allow a narrow passage to remain, forming a labyrinth type seal, between one end of the second leg and the surface portion of the upper cap.

Thus, the sealing lip includes either a double rubbing contact with the upper cap and the lower race, or a single rubbing contact with the lower race, such that a seal is formed by making a narrow passage with the upper cap.

According to another embodiment, the first leg cooperates with a surface portion of the upper cap and the second leg is in contact with a surface portion of the lower race. Thus, the second leg is in point contact with a surface portion of the lower race, allowing the sealing of the bearing to be increased.

The second leg can be in axial or radial contact with a surface portion of the lower race and the first leg can be in axial contact with a surface portion of the upper cap. The first leg can cooperate with a surface portion of the upper cap so as to allow a narrow passage to remain between an end of the first leg and the surface portion of the upper cap.

Analogously to the first embodiment, the sealing lip includes either a double rubbing contact with the upper cap and the lower race, or a single rubbing contact with the lower race, so as to form a seal by making a narrow passage with the upper cap.

The holding part and the sealing lip are realized in a same material, for example in synthetic material.

The upper cap can be provided with an annular outer skirt which defines, with the lower cap, an annular passage, the sealing lip being situated between the rolling elements and the annular passage, for example in the form of a labyrinth.

According to a second aspect, the invention concerns a suspension strut for a motor vehicle comprising a thrust bearing device as described above.

### BRIEF DESCRIPTION OF THE SEVERAL VIEWS OF THE DRAWINGS

Other characteristic and advantageous aims of the invention will become obvious by reading the following description, which is provided solely as a non-restricting example and is made with reference to the attached drawings, in which:

FIG. 1 shows a view in axial section of a suspension thrust bearing device according to a first embodiment of the invention,

FIG. 2 shows a view in the section 1141 of a suspension thrust bearing in FIG. 1,

FIG. 3 shows a detailed view of the suspension thrust bearing in FIG. 1 or 2,

FIG. 4 shows another embodiment of a suspension thrust bearing,

FIG. 5 shows a view in axial section of a second embodiment according to the invention of a suspension thrust bearing device,

FIG. 6 shows a view in the section VI-VI of a suspension thrust bearing in FIG. 5,

FIG. 7 shows a detailed view of the suspension thrust bearing in FIG. 5 or 6, and

FIG. 8 shows another embodiment of a suspension thrust bearing.

### DETAILED DESCRIPTION OF THE INVENTION

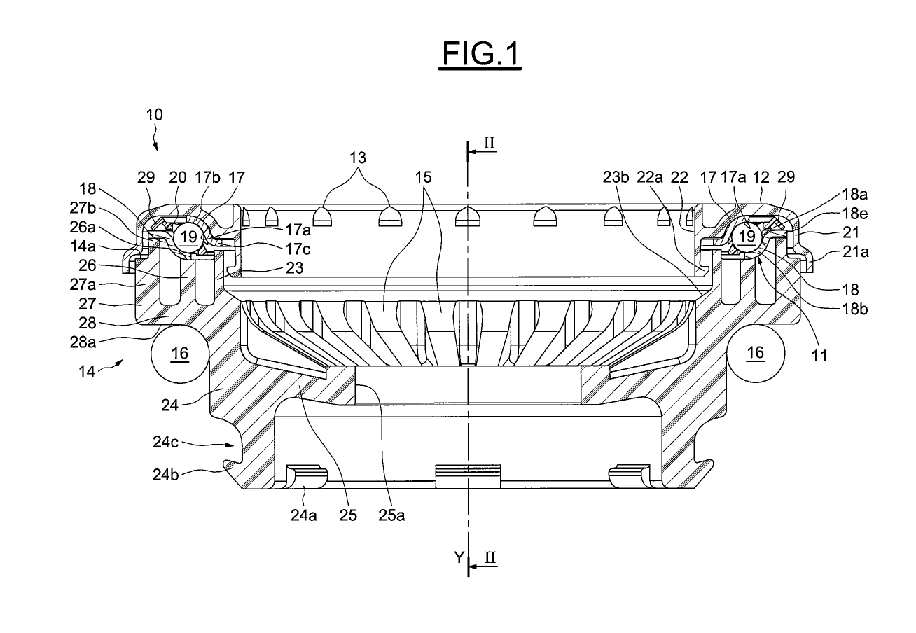

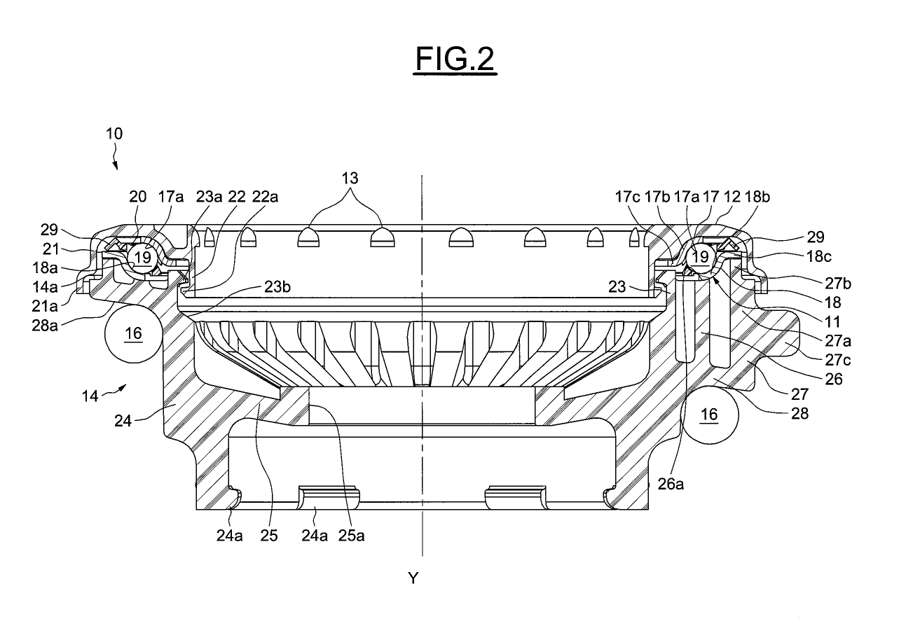

Referring to FIGS. 1 and 2, a suspension thrust bearing device 10 in accordance with the present invention basically comprises a roller bearing 11 mounted between an upper cap 12 with reinforcement means 13 on its bore and a lower cap 14 with reinforcement ribs 15 with an approximately rectangular cross section in the vicinity of its bore. The thrust bearing device 10 is intended to be integrated in a suspension strut of a motor vehicle (not shown) and includes a suspension spring 16, the top turn of which bears on the lower cap 14, and a suspension cylinder comprising a damper rod (not shown) with a supposed vertical Y axis. The suspension spring 16 is mounted around the damper rod. Preferably, the suspension thrust bearing device 10 is connected by means of the upper cap 12 to the body of the vehicle (not shown in the figure).

The roller bearing 11, from the Y axis, is a ball bearing in the example shown. The roller bearing 11 includes an upper race 17 mounted in the upper cap 12, a lower race 18 mounted on the lower cap 14, and a row of rolling elements 19, preferably ball elements, is disposed between the races 17, 18. More specifically, the rolling elements 19 are disposed between the roller tracks 17a, 18a formed by the upper 17 and lower 18 races, which may be formed of a single piece of sheet metal by cutting and stamping due to the fact that the outside diameter of the upper race 17 is approximately equal to the inside diameter of the lower race 18. A cage 20 is provided for keeping a regular peripheral spacing between the rolling elements 19, as described in greater detail below.

The lower race 18 includes an annular toroidal portion 18b which, in cross section, has a concave internal profile in the form of a quadrant and forms a toroidal roller track 18a for the rolling elements 19, the toroidal portion 18b being continued outwards by a radial portion 18c extending from an upper edge of the toroidal portion 18b. The upper race 17 also includes a toroidal portion 17b, which, in cross section, has a concave internal profile in the form of a quadrant and forms a toroidal roller track 17a for the rolling elements 19. The upper race 17 is in contact by way of its toroidal portion 17b with an inside surface of the upper cap 12, and the lower race 18 is in contact with an outside surface of the lower cap 14.

The upper cap 12, taken or viewed from the Y axis, has a general form of an annular flange. In the example shown, the upper cap 12 has an outer axial skirt 21 and an inner axial skirt 22. The roller bearing 11 is preferably housed entirely between the two skirts 21 and 22. The outer skirt 21 includes an outer annular edge 21a spaced from the annular edge 14a of the lower cap 14 to define a free space, thus forming a labyrinth type seal for the roller bearing 11. On the inside, the axial skirt 22 has a plurality of hooks 22a directed radially outwardly and are configured to cooperate with corresponding hooks 23a which are directed radially inwardly and form part of the lower cap 14. In operation, a free space is defined between the respective hooks 22a and 23a, which thus forms a labyrinth joint or seal for sealing the roller bearing 11.

The body of the lower cap 14, at its lower end, has a continuous annular portion 24 which extends axially downwardly. The annular portion 24 includes, in its lower part, a bead 24a which projects radially inwardly, a radial bead 24b which is directed outwardly and defines a throat 24c which enables, for example, a sealing boot (not shown) for the rod of the damper to be held. The end of the lower cap 14 follows axially a radial portion 25 which is slightly inclined downwardly and has a through-bore 25a for the rod of the damper. The body of the lower cap 14, at its upper end, has three annular fingers 23, 26, 27 which are connected by means of a radial portion 28 and extend axially towards the roller bearing 11 so as to hold the roller bearing 11 in an axial manner by way of its toroidal portion 17b. The axial length of each of the annular fingers 23, 26, 27 varies according to the periphery of the lower cap 14.

The outside finger 27 has a first axial portion 27a and a second axial portion 27b with a smaller diameter extending from the first portion 27a, such that the shape of annular edge 14a conforms to the shape of the outside axial skirt 21 and the outside annular edge 21a of the upper cap 12. The end of the second axial portion 27b is in contact with the radial portion 18c of the inside race 18. The end of the central finger 26 includes a toroidal outside bearing surface 26a of the inside race 18. The upper end of the spring 16 bears on a surface 28a of the radial portion 28 of the lower cap 14. The inside finger 23 includes the hook 23a which cooperates with the hook 22a and follows a conical portion 23b connecting the radial portion 28 to the annular portion 24.

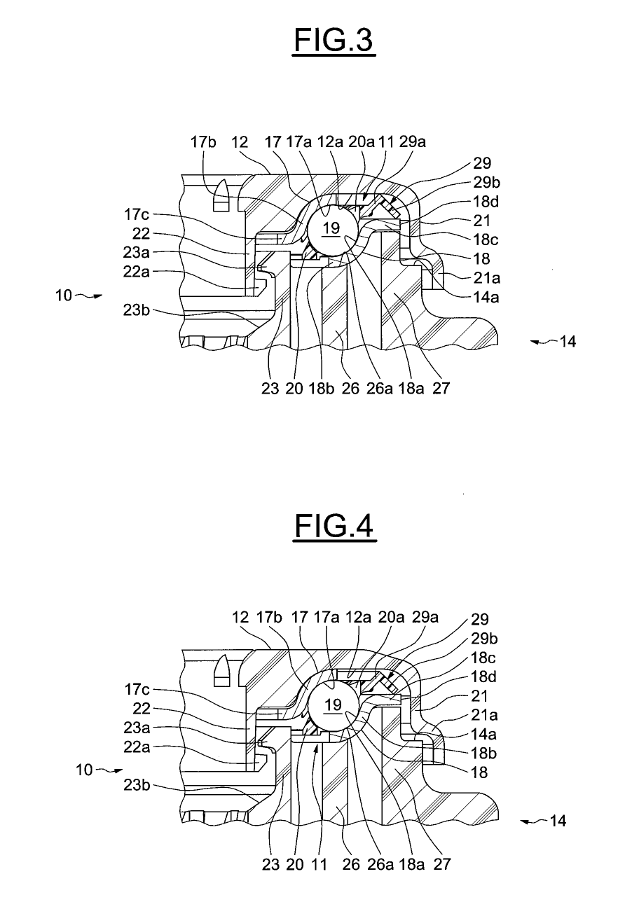

As best shown in FIGS. 3 and 4, the holding cage 20 is provided with a circumferential sealing lip 29 which extends generally outwardly from a holding part 20a. The sealing lip 29 substantially prevents the ingress of polluting particles between the outer axial skirt 21 of the upper cap 12 and the lower cap 14. Preferably, the sealing lip 29 has two legs 29a, 29b, which are integrally formed or connected and extend or project in generally opposing directions. The legs 29a, 29b “rubbingly” contact against an inside radial surface 12a of the upper cap 12 and against the radial portion 18c of the lower race 18, respectively.

The first sealing leg 29a extends in a generally oblique manner toward the radial surface 12a and the second sealing leg 29b extends in a generally oblique manner toward the radial portion 18c of the lower race 18. As shown in FIGS. 1 to 4, the end of the second sealing leg 29b is in generally axial contact with the lower race 18. Alternatively, the second sealing leg end may be in generally radial contact with an axial surface 18d of the radial portion 18c. The first and second legs 29a and 29b form a broken line generally shaped as a reversed “V”. The seal is thus reinforced by the two points of contact.

In the example shown in FIGS. 1 to 3, the end of the first sealing leg 29a is in generally axial contact with the upper cap 12. A seal is formed by rubbing or sliding contact of the first sealing leg 29a on the upper cap 12 and of the second sealing leg 29b on the lower race 18.

According to the embodiment shown in FIG. 4, the first sealing leg 29a has an end spaced from the upper cap 12 to define a relatively narrow passage so as to form a labyrinth type seal between the second leg end and the upper cap 12.

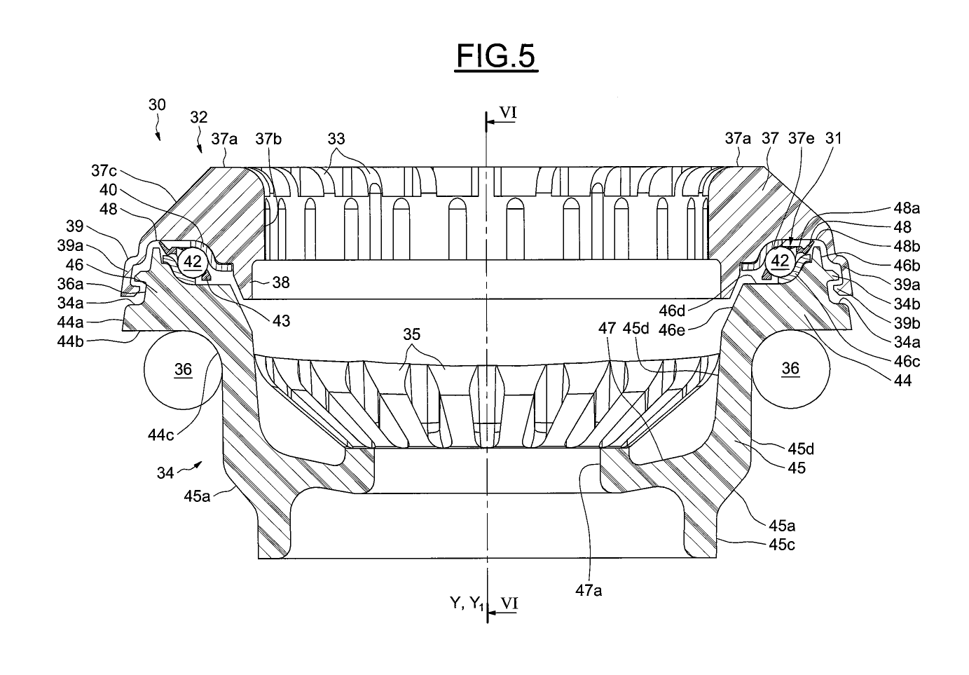

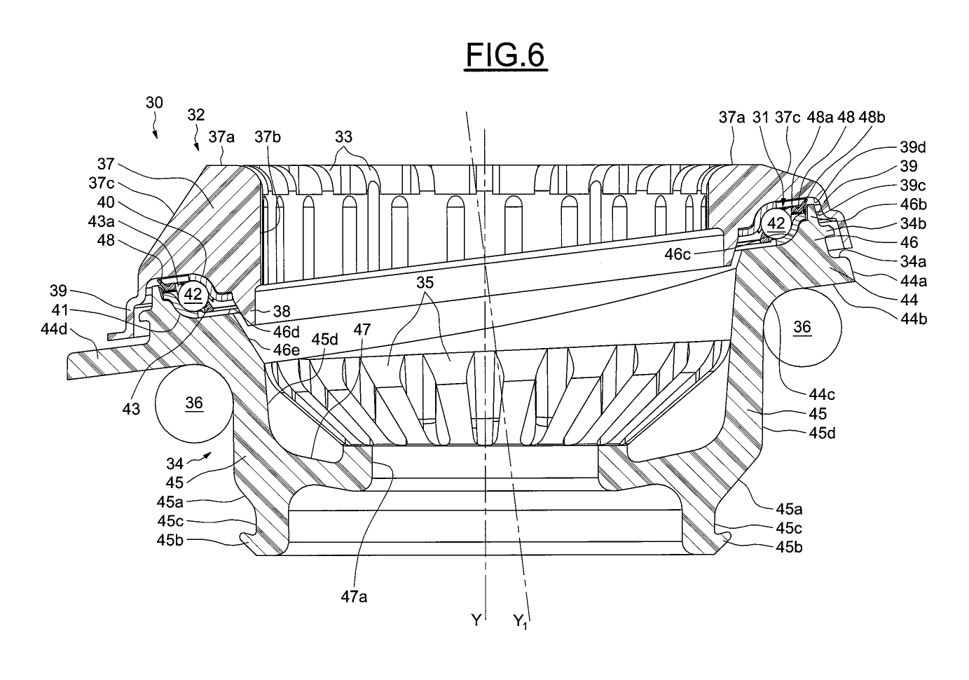

The embodiment of the thrust bearing device 30 shown in FIGS. 5 and 6 differs from the above-described thrust bearing device 10 in the shape of the upper and lower caps and the sealing lip. More specifically, the thrust bearing device 30 includes a roller bearing 31, mounted between an upper cap 32 which has reinforcement ribs 33 on its bore and a lower cap 34 which also has reinforcement ribs 35 on its bore. As with the thrust bearing device 10 shown in FIGS. 1 and 2, the thrust bearing device 30 is intended to be integrated in a suspension strut of a motor vehicle (not shown) that includes a suspension spring 36.

The body of the upper cap 32 includes an annular solid part 37, the upper radial surface 37a of which is configured to contact an element of the vehicle chassis. The annular solid part 37 has an approximately conical outer shape, the section of which varies according to the periphery of the upper cap 32.

The upper cap 32 has an inner annular axial skirt 38 which has a slightly conical section and extends generally toward the continuation of the bore 37b of the solid part 37, extending axially downwardly. The upper cap 32 also has a thin outer annular axial skirt 39 connected to the upper radial surface 37a by means of a conical portion 37c and includes an outer annular edge 39a spaced from the annular edge 34a of the lower cap 34 so as define a free space between the skirt 39 and the lower cap 34. An inwardly directed hook 39b, which may extend peripherally, is disposed in the bore of the outer axial skirt 39 in the vicinity of its lower end. The hook 39b is directed radially inwardly in the direction of the lower cap 34 and preferably cooperates with the corresponding hooks 34b of the lower cap 34, which are directed radially outwardly, so as to form a labyrinth type seal for the roller bearing 31.

The bearing 31, viewed or taken from the Y₁ axis, includes an upper race 40 mounted on the upper cap 32, a lower race 41 mounted on the lower cap 34, and a plurality of rolling elements 42 disposed between the races 40, 41, which are preferably ball elements. A cage 43 is also provided to allow a generally regular or even circumferential spacing between the rolling elements 42. The rolling elements 42 are disposed between the roller tracks 40a, 41a which are formed by the upper 40 and lower 41 races. As depicted in FIG. 6, the Y₁ axis of the bearing 31 is slightly inclined in comparison to the Y axis of the lower cap 34, while, according to FIG. 5, the Y and Y₁ axes are coaxial.

The upper race 40 has a toroidal portion 40b in contact with a complementary surface of the solid part 37 of the upper cap 32. A radial portion 40c extends inwardly from the toroidal portion 40b to the vicinity of a radial surface 37d of the solid part 37, from which extends the inner axial skirt 38. The inner surface of the toroidal portion 40b has, in cross section, a concave inner profile in the form of a quadrant and forms a toroidal roller track or path 40a for the rolling elements 42.

The lower race 41 also includes a toroidal portion 41b, the outer surface of which, in cross section, has a concave internal profile in the form of a quadrant and forms a toroidal roller track or path 41a for the rolling elements 42. The toroidal portion 41b contacts the lower cap 34 and has a short radial portion 41c extending generally outwardly. The cage 43 is disposed radially between the toroidal portion 40b of the upper race 40 and the toroidal portion 41b of the lower race 41.

The lower cap 34 includes a radial plate 44 and an annular axial skirt 45 which is arranged inwardly and extends axially downwardly contrary to the upper cap 32. The axial skirt 45 includes, at its lower end, a truncated portion 45a with an outwardly extending radial bead 45b defining a throat 45c, which enables the retention of, for example, a sealing boot (not shown) for the damper rod.

The radial plate portion 44 of the lower cap 34 includes a cylindrical outer surface 44a with a small axial dimension, from the end of which extends an annular radial surface 44b defining a bearing surface for the upper end turn of the suspension spring 36. The radial surface 44b is continued inwards and downwards by way of a rounded surface 44c, then by way of an outer axial surface 45a of the axial skirt 45, which allows the suspension spring 36 to be centred. The radial surface 44b may be appreciably inclined according to the periphery of the lower cap 34 and, as shown in FIG. 6, may have a radial tongue 44d which extends outwardly beyond the axial outer skirt 39 of the upper cap 32.

In the vicinity of the upper end of the cylindrical outer surface 44a, the radial plate 44 of the lower cap 34 includes an axial annular rib 46 which extends toward the upper cap 32 so as to define a space between the rib 46 and the cap 32. The axial rib 46 includes a hook 34b which is directed radially outwards in the direction of the upper cap 32. The hook 34b may be continuous peripherally and is arranged above the hook 39b of the upper cap 32, so as to be able to interfere diametrically with the hook 39b in the event that the upper cap 32 and lower cap 34 begin to separate. The hook 34b, therefore, forms an axial retaining means for the upper cap 32 in relation to the lower cap 34 to prevent separation of the elements constituting the device prior to mounting the device in the strut of a vehicle. Axially downwards, the hook 34b follows a throat 46a which is intended to cooperate with the hook 39b of the upper cap 32.

The axial rib 46 surrounds the lower race 41 of the bearing 31 in a radial manner. The upper end of the rib 46 has an axial continuation 46b and is continued inwards by way of the toroidal surface 46c in contact with the toroidal portion 41b of the lower race 41 and has a complementary form. The toroidal surface 46c is continued radially inwards by way of an annular radial surface 46d, from which extends an annular truncated surface 46e which is continued, in its turn, by way of an axial surface 45d inside the axial skirt 45. The axial surface 45d of the skirt 45 follows a radial portion 47 which is directed inwards and has a through-bore 47a for the rod of the damper.

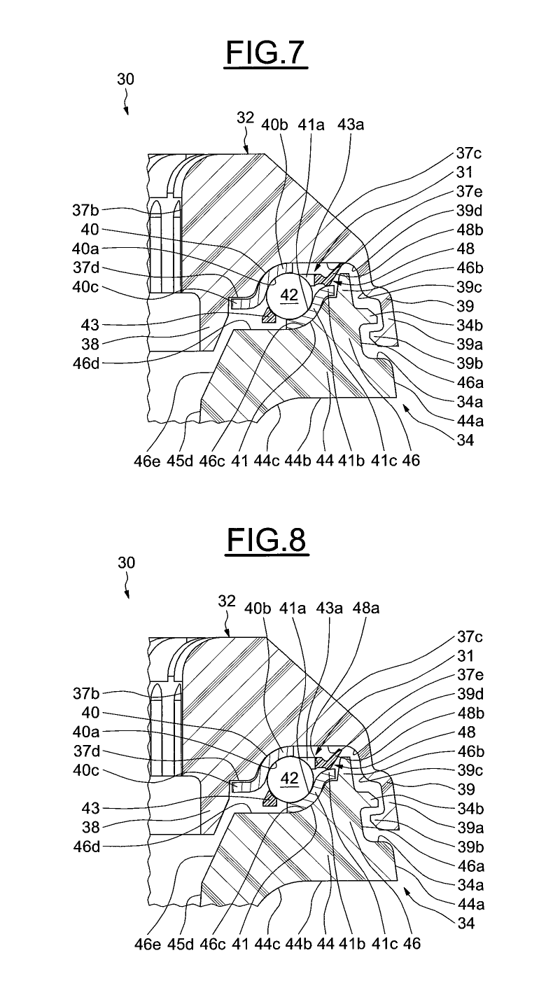

The holding cage 43, shown in more detail in FIGS. 7 and 8, is provided with a circumferential sealing lip 48 which extends outwards from the holding part 43a. The sealing lip 48 substantially prevents the ingress of polluting particles between the outer axial skirt 39 of the upper cap 32 and the lower cap 34. The sealing lip 48 has two legs 48a, 48b, which are integrally formed or connected and which extend or project in generally opposing directions. The legs 48a, 48b rubbingly or slidingly contact against the radial portion 41c of the lower race 41 and against the inner radial surface 37e of the solid part 37 of the upper cap 32.

The first sealing leg 48a extends in a generally oblique manner toward the end of the radial portion 41c and the second sealing leg 48b extends in a generally oblique manner toward the inner radial surface 37a of the upper cap 32. As shown in FIGS. 5 to 8, the end of the first sealing leg 48a is in generally axial contact with the lower race 41.

In the example shown in FIGS. 5 to 7, the end of the second sealing leg 48b is preferably in generally axial contact with the upper cap 32. Alternatively, the second sealing leg end may be in generally radial contact with the axial surface 39c of the outer skirt 39 or in oblique contact with the rounding 39d connecting the inner radial 37e and axial 39c surfaces. A seal is thus formed by rubbing/sliding contact of the first sealing leg 48a on the lower race 41 and of the second sealing leg 48b on the upper cap 32.

According to the embodiment shown in FIG. 8, the second sealing leg 48b has an end spaced from the upper cap 32 to define a relatively narrow passage so as to form labyrinth type seal between the second leg end and the upper cap 32.

In this embodiment, tilting of the roller bearing 31 enables a reduction in the radial loads that can be exerted by the suspension spring 36 while maintaining good distribution of axial loads exerted by the spring at the level of the roller bearing 31.

According to the different embodiments described above, the holding cage and the sealing lip are preferably formed of the same material, for example, a synthetic material, so as to reduce the manufacturing costs of the bearing.

In all of the embodiments described, the configuration of the sealing lip allows a good seal to be obtained with reduced frictional torque, whatever the configuration of the lower and upper caps. Moreover, the sealing lips provided on the holding cage, in contact on the lower race and on the upper cap, allow a sealed space containing the rolling elements of the bearing to be defined. This sealed space, sealed by the annular contact zones of the lips and reinforced by the narrow passages formed by the outer and inner axial skirts, avoids lubricant leakage to the outside of the roller bearing and ingress of pollutants.

It could be possible to provide a second sealing lip which extends inwards so as to strengthen the seal of the suspension thrust bearing.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A suspension thrust bearing device comprising:
a lower cap;
an upper cap spaced from the lower cap and having a surface portion; and
a bearing disposed between the lower and upper caps, the bearing including a lower race mounted on the lower cap, an upper race mounted on the upper cap, a plurality of rolling elements disposed between the two races, and a cage for retaining the rolling elements, the cage having a holding part for retaining the rolling elements and at least one sealing lip extending from the holding part toward an outer periphery of the bearing, the sealing lip including first and second integral legs extending in generally opposing directions, wherein one of:
the first leg cooperates with the surface portion of the upper cap and the second leg cooperates with the lower race to form a seal; and
the first leg cooperates with the lower race and the second leg cooperates with the surface portion of the upper cap to form a seal.

2. The thrust bearing device according to claim 1, wherein the lower race has a radial portion, the seal first leg contacts the radial portion of the lower race, and the seal second leg cooperates with the surface portion of the upper cap.

3. The thrust bearing device according to claim 2, wherein the seal second leg is in one of axial contact with the upper cap, radial contact with the upper cap, and oblique contact with the upper cap.

4. The thrust bearing device according to claim 2, wherein the seal second leg has an end spaced from the upper cap to define a narrow passage so as to form a labyrinth type seal between the second leg end and the upper cap.

5. The thrust bearing device according to claim 1, wherein the seal first leg cooperates with the surface portion of the upper cap and the seal second leg contacts the lower race.

6. The thrust bearing device according to claim 5, wherein the seal second leg is in one of axial contact with the lower race and radial contact with the lower race, and the seal first leg is in axial contact with the surface portion of the upper cap.

7. The thrust bearing device according to claim 5, wherein the seal first leg has an end spaced from the surface portion of the upper cap to define a narrow passage so as to form a labyrinth type seal between the end of the first leg and the upper cap.

8. The thrust bearing device according to claim 1, wherein the cage holding part and the sealing lip are formed of a same material.

9. The thrust bearing device according to claim 1, wherein the holding part and the sealing lip are each formed of a synthetic material.

10. The thrust bearing device according to claim 1, wherein the upper cap has an annular outer skirt, the upper cap annular skirt and the lower cap defining a generally annular passage, the sealing lip being generally disposed between the rolling elements and the annular passage.

11. A suspension strut for a motor vehicle, the strut comprising a thrust bearing device including:
a lower cap;
an upper cap spaced from the lower cap and having a surface portion; and
a bearing disposed between the lower and upper caps, the bearing including a lower race mounted on the lower cap, an upper race mounted on the upper cap, a plurality of rolling elements disposed between the two races, and a cage for retaining the rolling elements, the cage having a holding part for retaining the rolling elements and at least one sealing lip extending from the holding part towards an outer periphery of the bearing, the sealing lip including first and second integral legs extending in generally opposing directions, wherein one of:
the first leg cooperates with the surface portion of the upper cap and the second leg cooperates with the lower race to form a seal; and
the first leg cooperates with the lower race and the second leg cooperates with the surface portion of the upper cap to form a seal.
